(19) United States
(12) Patent Application Publication
(10) Pub. No.: US 2005/0144175 A1
(43) Pub. Date: Jun. 30, 2005

(54) Method and system for administrating use of a service

(75) Inventors: Diamantis Gikas, Nuernberg (DE); Werner Hoefler, Eckental (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/920,277

(22) Filed: Aug. 18, 2004

Related U.S. Application Data
(63) Continuation of application No. PCT/DE03/00511, filed on Feb. 18, 2003.

(30) Foreign Application Priority Data
Feb. 18, 2002 (DE) 10206691.4

(51) Int. Cl. G06F 7/00; G06F 17/30

(52) U.S. Cl. 707/10

(57) ABSTRACT

A method for using by a user (4), one or more services (16), which are stored in a memory (2) of a computer (1). The user (4) logs onto an administration unit (7), which monitors access to the service (16), and specifies the desired service (16). The administration unit (7) ascertains individual components (11, 12, 13) required for calling up a service (16) corresponding to the specification (15) and, for each required individual component (11, 12, 13), the administration unit (7) places an entry in a license data record (10) of a license database (9), which record is assigned to the user (4).

This is a Continuation of International Application PCT/DE03/00511, with an international filing date of Feb. 18, 2003, which was published under PCT Article 21(2) in German, and the disclosure of which is incorporated into this application by reference.

### BACKGROUND OF THE INVENTION

1. Field of the Invention

The present invention relates to a method for a user using a service which is stored in a memory of a computer and, more particularly, to a method for using a service stored in a memory, where the user logs onto an administration unit, which monitors access to the service, and specifies the desired service.

2. Description of Related Art

Methods for using a service are known, for example, in connection with the provision of software packages. The provision of software packages or their use may be described as using a service. Software packages of important software providers, e.g., for use in office automation, typically include an installation program. With the purchase of the software package, the user receives a storage medium on which the software package and the installation program are stored. The user executes the installation program on his or her computer to install the software package or parts thereof. The installation program offers options, which affect the scope of the installation depending on user's selection. Typical options are, for example, “minimum installation,” “standard installation” and “complete installation.” The installation program of such software packages may be described as an administration unit.

In addition, important software providers also offer the option to purchase the software they offer over the Internet. This, too, can be described as a service. To obtain the software using the Internet, the user dials up the computer or server of the software provider, specifies the desired software using a user interface and reaches an area where he can fetch the desired software. In this conventional technique, the user interface can be described as an administration unit. The user's computer may also be referred to as a terminal.

The disadvantage of these and other conventional methods, however, is that the user's options to influence the type and the scope of the requested service are limited. With conventional methods, the user can select, for example, whether he or she wants to buy or install software for word processing or spreadsheet analysis. But the user can only buy precisely the spreadsheet or word processing software made available by the provider and has no influence on the type and scope of the functions contained in the software. Furthermore, the user is billed for the software as a whole, irrespective of which functions he or she uses and to what extent he or she uses these functions.

### OBJECTS OF THE INVENTION

Thus, the object of the invention is to provide a method, which provides expanded options for the user to influence the type and scope of a required service. Another object of the present invention is to enable commensurate billing.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

### SUMMARY OF THE INVENTION

According to the exemplary, non-limiting embodiments of the present invention, a method for a user using at least one service which is stored in memory of a computer, is provided. The user logs onto an administration unit. The administration unit monitors access to the service and specifies the desired service. To this end, the administration unit ascertains individual components required for calling up a service corresponding to the specification. This administration unit considers the additional options of the user, who can individually compile the desired service by means of a corresponding specification. A service in this context is defined as the provision of a software corresponding to the user's specification. It is further provided that the administration unit places an entry for each individual component required in a license data record assigned to the user in a license database. This also makes it possible to individually calculate and bill the service, since each individual required component is stored in the license data record.

In general, software is modular and composed of a plurality of individual components. A software provider integrates obligatory components, standard components and specific components in the corresponding software. Obligatory components are components without which the software could not be operated. An example of a functionality of an obligatory component is the access to the corresponding hardware on which the software is to be run. Standard components are components without which the software would not be marketable, e.g., because every user expects to have the functionality provided by the standard components. An example of a functionality of a standard component is the loading and storing of data, which is to be processed by the software. A word processor, for example, typically also includes a standard component for text formatting. The remaining components can be classified as specific components. An example of the functionality of a specific component in a word processor is the creation of directories and indexes. Another example of the functionality of specific components in a word processor is a set of mathematical formulas or insertion of graphics. Depending on the user's concrete application, some, particularly the specific components, are used frequently, others rarely and other components may never be used by a particular user.

Accordingly to these illustrative embodiments of the present invention, the user can select the components that he or she actually needs by precisely specifying the desired service. In addition, the user can be billed based on the components required for the desired service.

Moreover, providing the service that is consistent with user's specifications often requires less memory than a comparable “standard service,” which has other functions besides those desired by the user and therefore requires more memory. Furthermore, a service with a reduced functionality, which is “custom tailored” to the user's preferences or needs, is often easier to master than a comparable standard service with a more extensive functionality. Finally, the user has an opportunity to try out a service, by first calling up only a reduced functionality and accordingly, the user is billed a smaller amount. If the user is satisfied with the service, he or she can call up additional functionalities and thereby adapt, for example, the capacity of a service to an individual learning progress.

According to the illustrative, non-limiting embodiments of the present invention, the provider may gain a general overview of the demanded functionalities and thus the corresponding individual components. As a result, the provider can target the development efforts to the needs of the users. The provider, furthermore, is provided with an opportunity to gain new customers more easily because the price for a complete standard service with a plurality of components is necessarily higher than the price for the use of individual components. An “entrance threshold” correlated with the price is therefore lower because the user can configure the corresponding service individually and is billed only for the components that he actually requested. Moreover, the provider may be able to optimize the production process. For example, the provider can reduce the costs of inventory. The provider does not need to create and market different services but can make the creation of the service dependent on the corresponding demand. Finally, the development of services can be made more flexible by dividing them into individual components and thereby decoupling them from one another.

According to another illustrative, non-limiting embodiment of the present invention, if the user is billed for the service by the administration unit on the basis of each required individual component, there is a close link for the user between each service that he or she uses and the result that can be achieved thereby. For example, consider an architect as the user. The architect, who wants to perform a special calculation, for example, or print out plans on a large format printer, will bill his own customer for the calculations or the plans. Thus, the service used, on the one hand, and the performance rendered and billable on the other, are directly correlated.

In addition, a use-monitoring unit may be provided to determine the duration and/or scope of the use of each individual component. As a result, it is possible to make the billing of the services called up by the user dependent on the nature of the corresponding use. One criterion can be the duration of the use. A complex calculation takes more time than a simple calculation and may therefore be billed differently than a simple calculation. An additional or alternative criterion is the scope of the use. The scope of the use can relate to the frequency of the use or to the corresponding required or determined data. For example, the scope of the use can also take into account that the same service is used repeatedly because the user is still inexperienced, or that a similar calculation is performed frequently, the parameters of which change only slightly.

Moreover, the administration unit may be a software program, which is stored in the same memory as the service that is being called up. On the one hand, this provides a sufficiently close link between the service and the administration unit, so that the administration unit has information available on each service that can be called up. On the other hand, this exemplary administration unit being a software program ensures the required flexibility of the administration unit when managing the services.

If the service is a software that corresponds to the specification, and the software is generated via the administration unit from the required number of individual components and is then used on the provider's computer (e.g. server) or some other remote computer, the user has a software that corresponds to his requirements. He can use the software regardless of whether his own computer has the necessary hardware, computing power or memory capacity.

If the service is a software corresponding to the specification generated by the administration unit from the required number of individual components and transmitted from the provider's computer to a user terminal where it is used, the user has a software that corresponds to his requirements available on his own computer.

Accordingly, the administration unit uses a dependency database to ascertain additional individual components, which are associated with each required individual component and are necessary to generate an executable software that includes all the individual components. For purposes of linguistic differentiation, an individual component is termed as a required individual component if it is provided to meet the user's specification. Any additional individual component ascertained with respect to each required individual component is either an obligatory component or a standard component. These additional individual components are termed as necessary individual components.

Consequently, the user does not need to be familiar with all the respective obligatory, necessary components or standard components. Even for users who posses detailed knowledge to specify all the obligatory components and standard components, such a comprehensive specification would be cumbersome, time-consuming and also error-prone. If the administration unit automatically ascertains the additional necessary individual components that pertain to the required individual component and are necessary to generate executable software, the user can confine himself or herself to a specification that reflects his or her requests and wishes.

In addition, if the use-monitoring unit is integrated in the generated software, the type and scope of the respective use can be ascertained even if access to, or use of the software takes place without the administration unit e.g., when the software is transferred to the user's terminal. The use-monitoring unit can be a component of the transferred software, which determines the type and scope of the use. These data are available for a use-based billing of the service.

If the computer is a remote computer from the user's perspective, e.g., a computer that can be reached over the Internet such as the provider's server, each service and the possibility of adapting and modifying previously used services, is available to the user from almost any location. As a result, the user does not depend, for example, on bringing along certain data media. The memory of the remote computer is therefore a remote memory. Such memories can be configured, for example, as distributed memories in a networked system with a combination of storage media. The administration unit may correspond to a remote administration unit.

Accordingly, the use-monitoring unit forwards use-related data to the remote administration unit. The use-related data are recorded by the use-monitoring unit to determine the duration and/or scope of the use of each individual component. This makes it possible for the use-monitoring unit, as a component of the transmitted software, to determine the type and scope of the use. The corresponding data is transferred to the administration unit at predefined or predefinable moments, e.g., at regular time intervals, or upon reaching a predefined or predefinable threshold with respect to the type and scope of the use.

The user may select the desired service or services from selection lists provided by the administration unit, thereby creating the specification. Once the specification is generated, it may be automatically forwarded to the administration unit. Thus, the user does not need to know all the possible specifications in advance. In addition, the selection list reduces the possibility of incorrect entries.

In addition, a license data record determines the scope of the selection list. This limits the possible specifications that the user can select. The selection list becomes more concise and includes only those specifications, which are possible in connection with previously called up services and the specifications made therefor.

### BRIEF DESCRIPTION OF THE DRAWINGS

The above and other features and advantages of the present invention will become more apparent by describing in detail illustrative, non-limiting embodiments thereof with reference to the attached drawings in which:

FIG. 1 illustrates a block diagram for executing the method according to the illustrative, non-limiting embodiment of the present invention,

FIG. 2 shows the content of a memory in accordance with the illustrative embodiment of the present invention, and

FIG. 3 illustrates the interaction of the elements stored in the memory in accordance with the illustrative embodiment of the present invention.

### DETAILED DESCRIPTION OF THE PREFERRED EMBODIMENTS

The present invention will now be described in detail by describing illustrative, non-limiting embodiments thereof with reference to the accompanying drawings._In the drawings, the same reference characters denote the same elements.

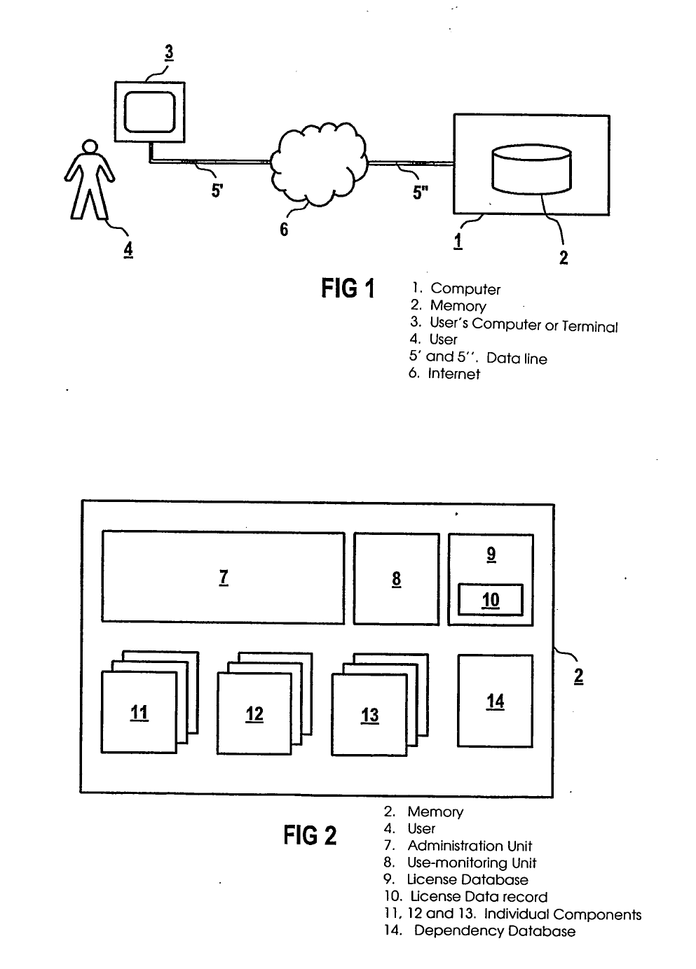

FIG. 1 shows a block diagram in which the method according to the illustrative, non-limiting embodiment of the present invention, can be used. In FIG. 1, a computer 1 is equipped with a memory 2. Moreover, a user 4 has a computer, which is referred to as a terminal 3. The computer 1 and the terminal 3 are communicatively linked via a date line 5′, 5″ and the Internet 6.

FIG. 2 shows the content of the memory 2 in accordance with the exemplary embodiment of the present invetion. The memory 2 contains an administration unit 7, a use-monitoring unit 8 and a license database 9 with a license data record 10 of the user 4 (FIG. 1). The memory 2 further stores a number of individual components 11, 12, 13 and a dependency database 14.

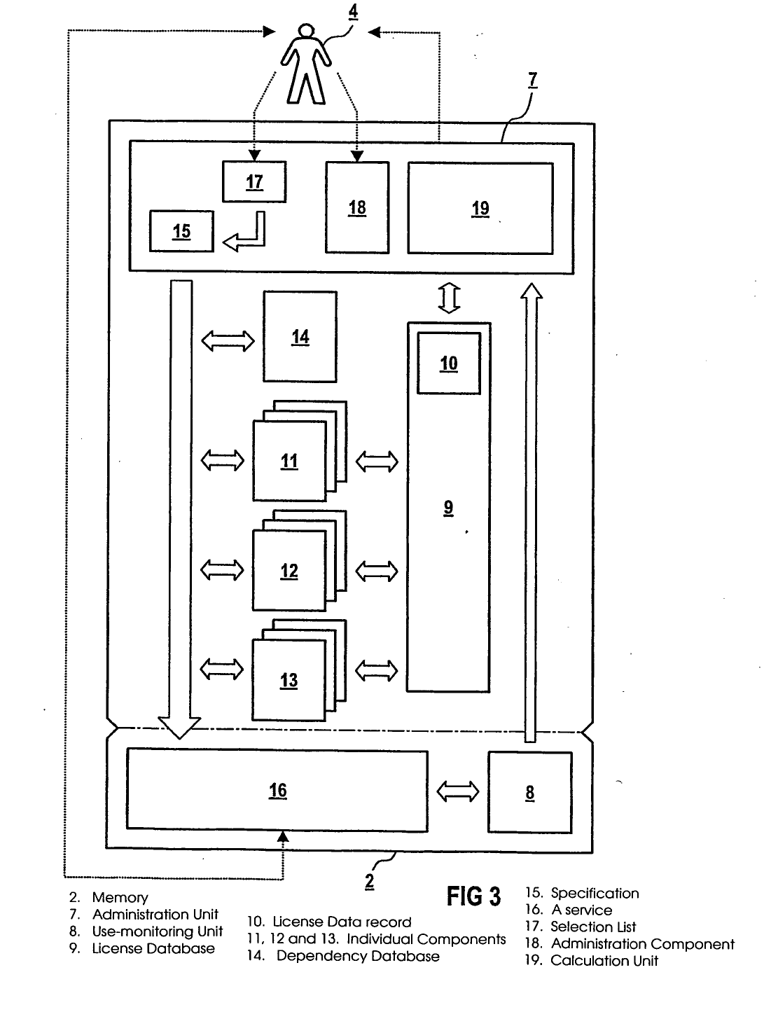

FIG. 3 illustrates the interaction of the elements 7, 8, 9, 10, 11, 12, 13, and 14 stored in the memory 2. The administration unit 7 uses a specification 15 to generate a service 16 from the individual components 11, 12, and 13, according to the dependency database 14. The vertical, downward pointing block arrow in FIG. 3 illustrates the generating of the service 16. The horizontal double arrows between the block arrow and the individual components 11, 12, 13, and the dependency database 14 in FIG. 3 illustrate the influence of these elements 11, 12, 13, and 14 on the generation of the service 16.

The specification 15 is a result of an entry made by the user 4 with the aid of a selection list 17. The dotted arrow between the user 4 and the selection list 17 illustrates input of user 4. The selection list 17 is presented to the user 4 by the administration unit 7 after the user has logged on with the aid of a user administration component 18. The user administration component 18 is a component of the administration unit 7. The user administration component 18 prompts the user 4 to enter a password, for example, which enables the administration component 18 to uniquely identify the user 4 and to distinguish between authorized users 4 and unauthorized users. The dotted arrow between the user 4 and the user administration component 18 in FIG. 3 illustrates the identification of the user 4. For each authorized user 4, the user administration component 18 obtains access to user-specific data (not depicted), e.g., the user's address. The user-specific data may also include bank information or an account kept by the provider of the service 16, into which the user 4 pays a certain amount, which is then reduced with each use of the service 16.

The selection list 17 includes one or more list of services that can be called up from, or by means of the administration unit 7. The selection list 17 can also include proposals for supplements or expansions of the services previously used by the user 4 or the services currently specified by the user 4. In principle, each individual component 11, 12, 13, and each allowable combination of the individual components 11, 12, 13 represents a separate service. Whether a combination of certain individual components 11, 12, 13 is allowable is determined by means of the dependency database 14. The dependency database 14 also indicates which other individual components 11, 12, 13 are necessary to use a certain individual component 11, 12, 13 and the service provided thereby.

The dependency database 14 is generated, for example, by the administration unit 7 with the aid of the information contained in the individual components 11, 12, 13 via existing interdependencies. By means of the specification 15, the user 4 selects certain individual components 11, 12, 13 or combinations thereof. These individual components 11, 12, 13 are the required individual components 11, 12, 13. Each required individual component 11, 12, 13 flows into the service 16. In addition to the required individual components 11, 12, 13, other individual components 11, 12, 13 can flow into the service 16 based on corresponding data of the dependency database 14. These additional individual components 11, 12, 13 are the necessary individual components 11, 12, 13. Without them, the required individual components 11, 12, 13 cannot be used. The combination of the required individual components 11, 12, 13 selected directly or indirectly by the user 4 with the aid of the specification 15 and the necessary individual components 11, 12, 13 ascertained by the administration unit 7 with the aid of the dependency database 14 form a service 16, which is a software program that can be executed by the user 4. The service 16 consists of providing the software program for use by the user 4. The dotted arrow between the user 4 and the service 16 illustrates the use of the service by the user and the associated generating of results for the user 4.

The service 16 that corresponds to the specification 15, is used either on the provider's computer 1 (FIG. 1) or is transmitted to the terminal 3 of the user 4 (FIG. 1) by the administration unit 7 and is used on that terminal 3. Billing the user 4 for the service 16 based on the type and scope of use. An entry is placed in the license data record 10 assigned to the user 4 in the license database 9 at least for each required individual component 11, 12, 13 and, in addition, where applicable, for each necessary individual component 11, 12, 13. This is illustrated in FIG. 3 by the horizontal double arrows between the individual components 11, 12, 13 and the license database 9.

To actually calculate the service 16 that has been used, the use-monitoring unit 8 and a calculation unit 19 are integrated in the administration unit 7. The use-monitoring unit 8 determines the duration and/or scope of the use of each required individual components 11, 12, 13 as a measure for the duration and/or scope of the use of the service 16, and, in addition, where applicable, each necessary individual component 11, 12, 13 that flowed into the service 16. With this data and the data of the license data record 10, the calculation unit 19 can calculate amount to bill for the service 16. The license data record 10 includes not only entries of the individual components 11, 12, 13 that flowed into the service 16 but also user-specific data, such as, for example, discounts in the form of quantity or customer discounts. Introductory prices in case of an initial offer of a service or in case of a first-time use of a service can also be taken into account. The dotted arrow between the administration unit 7 and the user 4 in FIG. 3 illustrates the billing for the use of the service 16 to the user 4.

The use-monitoring unit 8 can also be integrated in the service 16 (not depicted). In this case, the user 4 can use the service 16 on his terminal 3 (FIG. 1). The area of the memory 2 marked as “separable” by the horizontal dash-dotted line (FIG. 3) would then represent a memory (not further depicted) of the terminal 3. In this exemplary configuration, the use-monitoring unit 8 can forward the use-related data to the remote administration unit 7, e.g., via the Internet 6 (FIG. 1).

In summary, the exemplary, non-limiting embodiments of the invention can briefly be described as follows: Software components 11, 12, 13 are stored in a memory 2 of a remote computer 1. A service 16, which is a user-specific software, can be generated from these components in accordance with the specification 15 of a user 4. For this purpose, an administration unit 7 is provided, which monitors the access to the service 16. The user 4 logs onto this administration unit 7 and specifies the desired service 16. The administration unit 7 determines the software components 11, 12, 13 required for calling up the service 16 based on the specification 15. In addition, the administration unit 7 determines using the dependency database 14 if any additional components 11, 12, 13 are needed The administration unit 7 furthermore places an entry for each required individual component 11, 12, 13 in a license data record 10 assigned to the user 4 in a license database 9. In addition, the administration unit 7 may also place an entry for the necessary additional components into the license data record 10 assigned to user 4. Thus, the service 16, which is individually compiled for the user 4, can be billed to the user with respect to the selected components 11, 12, 13. Thus, the user 4 obtains custom software that contains only the required services. Moreover, the user 4 is billed only for the service he or she required and requested.

The user 4 can dial up a computer 1 of a software provider using his terminal 3, such as a programming device, e.g., via the Internet 6. There the user specifies the desired service 16 and selects, for example, components 11, 12, 13 for visualizing technical processes, components 11, 12, 13 for controlling and/or regulating technical processes and components 11, 12, 13 for recording and processing production data. The service 16, which is thus prepared individually for the user, represents, for example, a user-specific or custom development environment. The user 4 thereby generates a program to control and/or monitor a technical process, e.g., for a production line. The user 4 is billed for the service 16 he or she uses based on the user-selected components 11, 12, 13 and possibly based on the type and scope of the use of these components 11, 12, 13. This enables the user 4 to use a service 16, which corresponds to his specification or requirements 15 and for the use of which he or she can be billed in a manner that is closely linked to the work result produced by this user 4.

The above description of the illustrative, non-limiting embodiments has been given by way of an example. The above and other features of the invention including various novel method steps and a system of the various novel components have been particularly described with reference to the accompanying drawings and pointed out in the claims. It will be understood that the particular process and construction of parts embodying the invention is shown by way of illustration only and not as a limitation of the invention. The principles and features of this invention may be employed in varied and numerous embodiments without departing from the scope of the invention as defined by the appended claims and equivalents thereof.

1. A method for a user to use at least one service stored in a memory of a computer, wherein the user logs onto an administration unit, which monitors the access to the service, and the user provides a specification of the desired service, the method comprising:
the administration unit determining individual components required for calling up the service corresponding to the specification, and
the administration unit placing an entry in a license data record assigned to the user in a license database for each required individual component.

2. The method as claimed in claim 1, wherein the administration unit is a software program stored in the memory from which the service is called up.

3. The method as claimed in claim 1, wherein the service is a software defined by the specification and generated by the administration unit from the required number of individual components, and wherein the service is used on the computer.

4. The method as claimed in claim 1, wherein the user is billed by the administration unit for the service based on the individual components required for the service.

5. The method as claimed in claim 4, wherein the administration unit is a software program stored in the memory from which the service is called up.

6. The method as claimed in claim 4, wherein the service is a software defined by the specification and generated by the administration unit from the required number of individual components, and wherein the service is used on the computer.

7. The method as claimed in claim 4, wherein a use-monitoring unit ascertains at least one of a duration and a scope of use of the required individual components.

8. The method as claimed in claim 7, wherein the administration unit is a software program stored in the memory from which the service is called up.

9. The method as claimed in claim 7, wherein the service is a software defined by the specification and generated by the administration unit from the required number of individual components, wherein the service is used on the computer.

10. The method as claimed in claim 9, wherein the use-monitoring unit is integrated in a software of the service.

11. The method as claimed in claim 1, wherein the service is a software defined by a corresponding specification and generated by the administration unit from the required number of individual components, wherein the service is transmitted from the computer to a terminal of the user, and wherein the service is used on the terminal of the user.

12. The method as claimed in claim 11, wherein the use-monitoring unit transmits use-related data to the remote administration unit.

13. The method as claimed in claim 1, wherein the administration unit uses a dependency database to determine additional individual components related to the required components, and wherein the additional components are necessary to generate the service comprising a comprehensive executable software.

14. The method as claimed in claim 1, wherein the computer is a remote computer from perspective of the user.

15. The method as claimed in claim 14, wherein the use-monitoring unit transmits use-related data to the remote administration unit.

16. The method as claimed in in claim 1, wherein the user transmits the specification by making a selection from a selection list provided by the administration unit.

17. The method as claimed in claim 16, wherein scope of the selection list is determined by a license data record.

18. A method for customizing at least one service stored in a memory based on user input, the method comprising:
logging onto an administration unit by a user;
selecting from a list of services provided by the administration unit, at least one service to access;
generating a specification corresponding to the selected at least one service;
determining by the administration unit individual components required for calling up the selected at least one service; and
adding data to a license data record assigned to the user in a license database for each of the required components.

19. A method as claimed in claim 18, further comprising determining by the administration unit additional components necessary for executing the required components and adding data to the license record assigned to the user for each of the additional components.

20. A system for customizing at least one software program, stored in memory, based on user input, the system comprising:
a terminal providing a user with a list for selecting at least one software program for use by the user and generating a specification based on the user selection;
a dependency database linking services with required components and linking the required components with additional components necessary for execution of the required components;
a license database comprising a license data record assigned to the user; and
an administration unit determining components required for the selected at least one software program using the specification and the dependency database and adding data to the license record based on the components determined to be required for the selected at least one software program.
